(19) United States
(12) Patent Application Publication
(10) Pub. No.: US 2018/0347509 A1
(43) Pub. Date: Dec. 6, 2018

(54) APPARATUS, SYSTEMS, AND METHODS FOR PROVIDING AN AIR-FUEL MIXTURE TO AN ENGINE

(71) Applicant: Brent Wesley Wouters, Atlanta, GA (US)

(72) Inventor: Brent Wesley Wouters, Atlanta, GA (US)

(21) Appl. No.: 15/994,652

(22) Filed: May 31, 2018

Related U.S. Application Data
(60) Provisional application No. 62/513,914, filed on Jun. 1, 2017.

(51) Int. Cl. F02M 21/04; F02M 29/00; B01F 5/04; B01F 3/04

(52) U.S. Cl. CPC F02M 21/047; F02M 29/00; B01F 2215/0086; B01F 3/0446; B01F 5/0413

(57) ABSTRACT

An apparatus for mixing fuel and air and providing the mixture to an engine can include an entry conduit, a transfer conduit, and a mounting plate for coupling to an engine. The entry conduit can include a straight channel and an opening for receiving air into the channel. The entry conduit can also include a fuel inlet port disposed through a wall of the entry conduit for receiving fuel into the channel. A venturi valve can be disposed within the straight channel and can include an air-fuel mixing chamber, an inner wall, one or more fuel orifices disposed through the inner wall, and a fuel diffusion chamber fluidicly coupled to the fuel inlet port and the air-fuel mixing chamber. The transfer conduit can be coupled or integrally formed with the entry conduit and include an arcuate internal channel.

### RELATED APPLICATIONS

This application claims priority under 35 U.S.C. § 119 to U.S. Provisional Patent Application No. 62/513,914 filed Jun. 1, 2017, and titled “Apparatus, Systems, and Methods for Providing an Air-Fuel Mixture to an Engine,” the entire contents of which are hereby incorporated herein by reference for all purposes.

### TECHNICAL FIELD

The present disclosure relates generally to internal combustion engines and more particularly to a method, system, and apparatus for mixing air and fuel for supplying an internal combustion engine.

### BACKGROUND

A number of conventional techniques exist for mixing fuel and air and then providing that to an internal combustion engine. However, conventional techniques typically require secondary methods for adjusting the amount of fuel or air ratio in the mixture to correct a mixture that is too lean (not enough fuel in the ratio) or too rich (too much fuel in the ratio). These secondary methods can include a choke valve, that adjusts the amount of air provided to the mixture. However, the requirement of a choke valve results in a device that has additional parts that can break or get out of proper alignment. In addition, while these conventional techniques generally mix the fuel with the air, improving the diffusion of the fuel into the air to create the fuel/air mixture will result in a fuel that is burned more efficiently, result in lower hydrocarbons during combustion and ultimately result in a cleaner burning engine. In some instances, different fuels can be burned in an engine, such as gasoline, propane, or other liquid hydrocarbons, wherein each fuel may have different combustion characteristics.

### BRIEF DESCRIPTION OF THE FIGURES

For a more complete understanding of the present disclosure and certain features thereof, reference is now made to the following description, in conjunction with the accompanying figures briefly described as follows:

FIG. 1 illustrates a combustion engine system that includes an air-fuel mixing apparatus according to at least one example embodiment of the disclosure.

FIG. 2 is an exploded view of the air-fuel mixing apparatus according to at least one example embodiment of the disclosure.

FIG. 3 is a side elevation view of the air-fuel mixing apparatus according to at least one example embodiment of the disclosure.

FIG. 4 is a cross-sectional view of the air-fuel mixing apparatus according to at least one example embodiment of the disclosure.

FIG. 5 is an elevation view of one end of the air-fuel mixing apparatus according to at least one example embodiment of the disclosure.

FIG. 6 is another side elevation view of the air-fuel mixing apparatus according to at least one example embodiment of the disclosure.

FIG. 7 is an elevation view of an end of the air-fuel mixing apparatus opposite the end of FIG. 5 according to at least one example embodiment of the disclosure.

FIG. 8 is a block diagram of an example processing and output architecture or system that may be utilized with the system of FIG. 1 in accordance with various example embodiments of the disclosure.

### DETAILED DESCRIPTION OF EXAMPLE EMBODIMENTS

Example embodiments now will be described more fully hereinafter with reference to the accompanying drawings, in which example embodiments are shown. The concepts claimed and described herein may, however, be embodied in many different forms and should not be construed as limited to the example embodiments set forth herein; rather, these embodiments are provided so that this disclosure will be thorough and complete, and will fully convey the scope of the claimed invention to those skilled in the art. Like numbers refer to like, but not necessarily the same, elements throughout.

Certain dimensions and features of the example air-fuel mixing apparatus and system are described herein using the term “approximately.” As used herein, the term “approximately” indicates that each of the described dimensions is not a strict boundary or parameter and does not exclude functionally similar variations therefrom. Unless context or the description indicates otherwise, the use of the term “approximately” in connection with a numerical parameter indicates that the numerical parameter includes variations that, using mathematical and industrial principles accepted in the art (e.g., rounding, measurement or other systematic errors, manufacturing tolerances, etc.), would not vary the least significant digit.

In addition, certain relationships of the air-fuel mixing apparatus and system are described herein using the term “substantially.” As used herein, the terms “substantially” and “substantially equal” indicates that the relationship or equal relationship is not a strict relationship and does not exclude functionally similar variations therefrom. Unless context or the description indicates otherwise, the use of the term “substantially” or “substantially equal” in connection with two or more described dimensions or elements indicates that the equal relationship between the dimensions or elements includes variations that, using mathematical and industrial principles accepted in the art (e.g., rounding, measurement or other systematic errors, manufacturing tolerances, etc.), would not vary the least significant digit of the dimensions or elements. As used herein, the term “substantially constant” indicates that the constant relationship is not a strict relationship and does not exclude functionally similar variations therefrom. As used herein, the term “substantially parallel” indicates that the parallel relationship is not a strict relationship and does not exclude functionally similar variations therefrom.

Certain embodiments of the disclosure are directed to apparatus, systems, and methods for providing a fuel-air mixture to an engine. In one example embodiment, a device may provide fuel to an engine, the device including a conduit with an inlet to receive an air flow and a fuel inlet to receive a fuel, a venturi positioned in the conduit to receive the fuel and the air flow and to mix the fuel with the air flow, a curve-shaped portion to provide a fuel-air mixture from the conduit to a mounting portion, the mounting portion operatively connecting the device to the engine and configured to provide the fuel-air mixture to the engine.

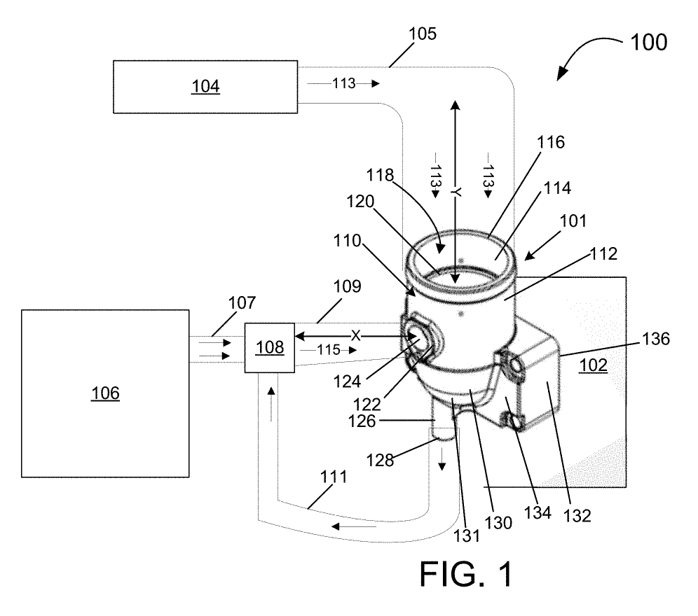

FIG. 1 presents an example combustion engine system 100 that includes an air-fuel mixing apparatus according to at least one example embodiment of the disclosure. Referring now to FIG. 1, the system 100 can include an air-fuel mixing apparatus 101. The air-fuel mixing apparatus 101 can have many different shapes and features. Examples of certain shapes and features for the air-fuel mixing apparatus 101 will be provided below. However, these examples are not intended to be required or limiting in any manner.

In one example, the air-fuel mixing apparatus 101 can include an entry conduit 110, a transfer conduit 130, and a mounting plate 132. In certain example embodiments, the combination of the entry conduit 110 and transfer conduit 130 can be referred to herein as a mixing conduit. In certain example embodiments, one or more of the entry conduit 110, transfer conduit 130, and mounting plate 132 may be integrally formed together. In other embodiments, one or more of the entry conduit 110, transfer conduit 130, and mounting plate 132 may be individually constructed and then coupled to one or more of the other ones of the entry conduit 110, transfer conduit 130 and mounting plate 132. For example, the components of the air-fuel mixing apparatus 101 can be constructed of metal and welded to one another. Positionally, the transfer conduit 130 can be positioned along a flow path between the entry conduit 110 and the mounting plate 132.

The entry conduit 110 can be constructed of one or more pieces or components and can include an outer wall 112 and an inner wall 114 defining a passageway or channel 118 through the entry conduit 110. In certain examples, the outer wall 112 and the inner wall 114 can have generally cylindrical shapes. However, in other examples the outer wall 112 and the inner wall 114 can have any other shape and the shapes of the outer wall 112 and the inner wall 114 can be the same or different. The passageway or channel 118 through the entry conduit 110 and along the longitudinal axis of the entry conduit 110 can extend along a longitudinal axis Y. The diameter of the passageway or channel 118 may be consistent or may vary. In one embodiment, the diameter of the passageway or channel 118 may be between substantially 60.0 millimeters (mm) and substantially 70.0 mm. In other example embodiments, other dimensions for the passageway or channel 118 may be employed. The entry conduit 110 can also include an open top end or rim 116 defining an opening into the passageway or channel 118. The top end or rim 116 can have a circular or substantially circular shape and can be an inlet for air into the air-fuel mixing apparatus 101 along an air flow path 113. In certain example embodiments, the diameter of the opening defined by the top end or rim 116 can be between substantially 50 mm and substantially 70 mm. In other example embodiments, other dimensions may be employed. The amount of air introduced into the air-fuel mixing apparatus 101 may be controlled by the area of the opening defined by the top end or rim 116. For example, an opening having a relatively larger surface area may allow for more air than an opening having a relatively smaller surface area.

The entry conduit 110 can also include a fuel inlet port 122 for receiving fuel into the air-fuel mixing apparatus 101 along a fuel flow path 115. In certain example embodiments, the fuel inlet 122 can be disposed along and through the outer wall 112 along the side of the entry conduit 110. The fuel inlet port 122 can define an opening 124 that extends through the outer wall 112 and inner wall 114 of the entry conduit 110 and into the passageway or channel 118. The opening 124 can have a circular or substantially circular shape and can have a diameter that is less than the diameter of the opening defined by the rim 116. In certain example embodiments, the diameter of the opening 124 may be between substantially 10 mm and substantially 30 mm. In other example embodiments, other dimensions for the opening 124 may be used.

In certain examples, the amount of fuel introduced into the air-fuel mixing apparatus 101 can be controlled by the surface area of the opening 124. For example, a relatively larger surface area for the opening 124 can allow for more fuel into the air-fuel mixing apparatus 101 than an opening 124 having a smaller surface area. In certain other example embodiments, a fitting can be coupled to the fuel inlet port 122 or press-fit into the opening 124 to reduce the diameter of the opening 124 to control the rate that fuel is supplied to the air-fuel mixing apparatus 101. In one example, the opening 124 can define a second passageway or channel into the air-fuel mixing apparatus 101 that extends along a longitudinal axis X. In certain example embodiments, the longitudinal axis X is perpendicular to or substantially perpendicular to the longitudinal axis Y such that the air flow path 113 into the air-fuel mixing apparatus 101 is perpendicular to or substantially perpendicular to the fuel flow path 115 into the air-fuel mixing apparatus 101.

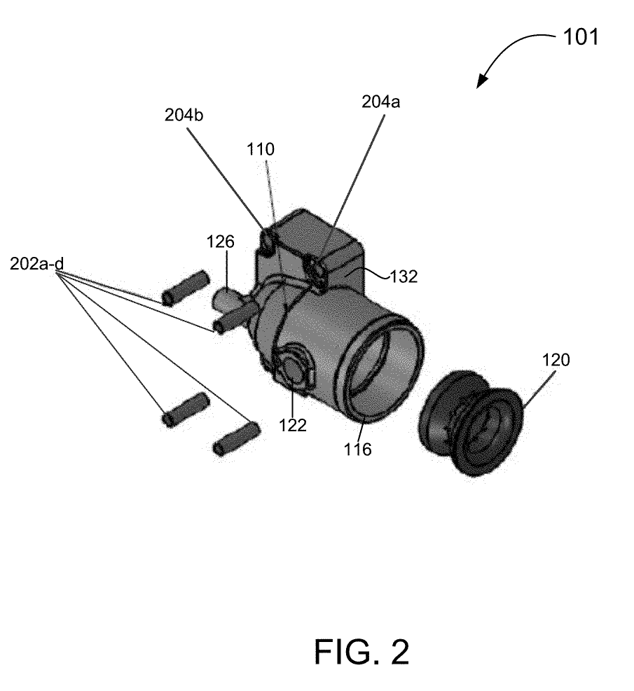

FIG. 2 is an exploded view of the air-fuel mixing apparatus 101 according to at least one example embodiment of the disclosure. Referring to FIGS. 1 and 2, the air-fuel mixing apparatus 101 can also include a venturi valve 120. The venturi valve 120 can be constructed or metal or another material. The venturi valve 120 can be inserted into the passageway or channel 118 of the entry conduit 110 and can be positioned between the rim 116 and the transfer conduit 130. The venturi valve 120 can be configured to receive air via the air flow path 113 and fuel via the fuel flow path 115 in order to mix the fuel with the air prior to transfer of the air-fuel mixture to an engine 102. The venturi valve 120 can be press fit into the passageway or channel 118 such that portions of the venturi valve 120 contact the inner wall 114 of the entry conduit to create a seal between that portion of the venturi valve 120 and the inner wall 114. Alternatively, the venturi valve 120 may be otherwise coupled to the entry conduit along the inner wall 114 and a sealant may be applied to prevent the passage of air or fuel around the top end of the venturi valve 120 between the top end and the inner wall 114.

The air-fuel mixing apparatus 101 can also include a transfer conduit 130 coupled to or integrally formed with the entry conduit 110 along a second end opposite the rim or top end 116. The opposing second end of the transfer conduit 130 is coupled to or integrally formed with the mounting plate 132. The transfer conduit 130 can include an outer wall 131 and an inner wall (not shown) that defines third channel or passageway in fluidicly coupled with the passageway or channel 118. In one example, the third channel or passageway is configured to transmit the air-fuel mixture from the venturi valve 120 into the combustion chamber of the engine 102. The third channel or passageway adjusts the flow of the air-fuel mixture from a first direction substantially along the longitudinal axis Y to a second direction, which is at an angle from the first direction. In one example, the angle of change of flow path for the air-fuel mixture in the third channel or passageway is within a range of substantially 30 degrees to substantially 150 degrees and more preferably within a range of substantially 60 degrees to substantially 120 degrees and even more preferably within a range of substantially 80 degrees to substantially 100 degrees and even more preferably substantially 90 degrees. In certain example embodiments, the flow of the air-fuel mixture after exiting the venturi valve 120 and passing through the third channel or passageway in the transfer conduit changes from along or substantially along the longitudinal axis Y to along or substantially along the longitudinal axis X. In certain examples, the transition of the fuel from along the curvature of the third channel or passageway from the first direction to the second direction causes additional turbulence as the air-fuel mixture has different flow rates depending on the proximity of the air-fuel mixture to the inner or outer radiuses of the curvature in the transfer conduit, which results in additional and improved mixing of the air and fuel in the air-fuel mixture prior to it being supplied to the engine 102.

The air-fuel mixing apparatus 101 can also include a vacuum tap 126 coupled to or integrally formed with the transfer conduit 130. In certain example embodiments, the vacuum tap 126 can be a cylindrical or substantially cylindrical pipe with a fourth channel or passageway extending therethrough. In other embodiments, the vacuum tap 126 can be any other shape or have other dimensions. The example vacuum tap of FIG. 1 has a first end that extends through the outer wall 131 of the transfer conduit 130 and is fluidicly coupled to the third channel or passageway and a distal second end 128. In one example, the vacuum tap 126 longitudinal axis of the fourth channel or passageway through the vacuum tap 126 is parallel or substantially parallel with the longitudinal axis Y of the passageway or channel 118 of the inlet conduit and perpendicular or substantially perpendicular to the longitudinal axis X of the opening 124 through the fuel inlet port 122. The vacuum tap 126 can be operatively coupled to an engine component to draw a portion of the air flow from the entry conduit 110 and/or transfer conduit 130. In certain example embodiments, a vacuum can be generated at one end of the vacuum tap 126 to create an air flow through the vacuum tap 126. In this manner, air flow through the entry conduit 110 and/or transfer conduit 130 can be further controlled as needed.

The air-fuel mixing apparatus 101 can also include a mounting plate 132 or other means for mounting the air-fuel mixing apparatus 101 to an engine 102. In certain example embodiments, the mounting plate 132 can include a first mounting surface 134 and an opposing second mounting surface 136. At least a portion of one or both of the first mounting surface 134 and second mounting surface 136 can be flat or substantially flat. In certain example embodiments, the transfer conduit 130 can be coupled to or be integrally formed with and extend out from the first mounting surface 134. The second mounting surface 136 can abut the engine 102 or another component of the engine for coupling the air-fuel mixing apparatus 101 to the engine 102. In one example embodiment, the length of the mounting plate 132 can be between substantially 90.0 millimeters (mm) and substantially 100.0 mm, and the width of the mounting plate 132 can be between substantially 40.0 mm and substantially 50.0 mm. In other example embodiments, other dimensions for the mounting plate may be employed. Further, while the example embodiment presents a mounting plate 132 having a generally rectangular shape, this is also for example purposes only as any other shape for the mounting plate 132 may be used and be within the scope and spirit of this disclosure.

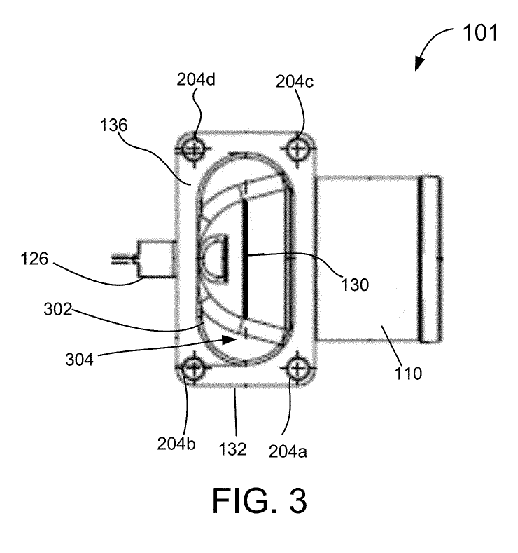

FIG. 3 is a side elevation view of the air-fuel mixing apparatus 101 according to at least one example embodiment of the disclosure. Referring to FIGS. 1-3, the mounting plate 132 can also include one or more mounting holes 204a-204d. Each mounting hole 204a-204d can extend through the entire body of the mounting plate 132 from the first mounting surface 134 to the second mounting surface 136. Each mounting hole 204a-204d can be threaded or a through-hole (unthreaded). While the example embodiment presents four mounting holes 204a-204d each positioned adjacent a respective corner of the mounting plate 132, this is for example purposes only, as greater or fewer mounting holes may be provided and the positioning of those mounting holes can be anywhere along the body of the mounting plate 132.

The mounting plate 132 can also include a fifth passageway or channel 304 (e.g., an air-fuel mixture delivery channel) that extends through the body of the mounting plate 132 from the first mounting surface 134 to the second mounting surface 136 and is fluidicly coupled to the third channel or passageway of the transfer conduit 130. The fifth channel or passageway 304 can have a shape defined by a sidewall 302 at the opening of the passageway 304 along the second mounting surface 136. In one example, the longitudinal axis of the fifth channel or passageway from the first mounting surface 134 to the second mounting surface 136 is perpendicular or substantially perpendicular with the longitudinal axis Y of the passageway or channel 118 of the entry conduit 110 and parallel or substantially parallel to the longitudinal axis X of the opening 124 through the fuel inlet port 122. While the example embodiment of FIG. 3 presents the shape of the fifth channel or passageway 304 as elliptical, this is for example only as any other shape or size of passageway 304 may be substituted for that shown in FIG. 3. The example shape for the passageway 304 and sidewall 302 shown in FIG. 3 is for mounting to the combustion chamber of a combustion engine 102.

The air-fuel mixing apparatus 101 can also include one or more coupling means 202a-202d for coupling the air-fuel mixing apparatus 101 to an engine 102. In certain examples, the coupling means 202a-202d can be any one or more of bolts, screws, pins, rivets or other coupling devices known to those or ordinary skill in the art. Each coupling means 202a-202d can be configured to extend through one of the corresponding mounting holes 204a-204d to coupled the mounting plate 132 to the engine 102 or another engine component. While the example embodiment presents four coupling means 202a-202d each positioned adjacent a respective mounting hole 204a-204d, this is for example purposes only, as greater or fewer coupling means 202a-202d may be provided and the positioning of those coupling means 202a-202d can be anywhere along the body of the mounting plate 132.

The system 100 can also include an air filter 104 or other form of air supply. The air-fuel mixing apparatus 101 can be directly or indirectly fluidicly coupled to the air filter 104 or other air supply. In one example, the air-fuel mixing apparatus 101 is fluidicly coupled to the air filter 104 with a pipe 105. The pipe 105 can have a first end coupled to the air filter 104 and a distal second end coupled along the top end 116 of the entry conduit 110 of the air-fuel mixing apparatus 101. The pipe 105 can represent one or multiple pipes and can be rigid or flexible (e.g., a rubber hose). The air filter 104 can be configured to provide filtered ambient air to the air-fuel mixing apparatus 101 via an air flow path 113 through the pipe 105.

The system 100 can also include a fuel tank 106 or other form of fuel supply. The air-fuel mixing apparatus 101 can be directly or indirectly fluidicly coupled to the fuel tank 106 or other form of fuel supply. The fuel tank 106 can be configured to store a volume of fuel for use in the system 100. In one example, the fuel tank 106 is directly or indirectly fluidicly coupled to a regulator 108 with a pipe 107. The regulator 108 can be directly or indirectly fluidicly coupled to the air-fuel mixing apparatus 101 with a pipe 109. For example, the pipe 107 can have a first end coupled to the fuel tank 106 and a distal second end coupled to the regulator 108. Further the pipe 109 can have a first end coupled to the regulator 108 and a distal second end coupled to the fuel inlet port 122 on the air-fuel mixing apparatus 101. In certain example embodiments, other devices may be positioned between the fuel tank 106 and the regulator 108 and/or between the regulator 108 and the air-fuel mixing apparatus 101, such as a fuel filter or other components. The pipes 107, 109 can represent one or multiple pipes and can be rigid or flexible (e.g., a rubber hose). The fuel tank 106 can be configured to provide fuel to the air-fuel mixing apparatus 101 via a fuel flow path 115 through the pipes 107, 109. The regulator 108 can be configured to increase the pressure of the fuel along the fuel flow path 115 between the fuel tank 106 and the air-fuel mixing apparatus 101.

The system 100 can also include a pipe 111 the provide a fluidic path between the vacuum tap 126 and the regulator 108. For example, one end of the pipe 111 can be coupled to the end 128 of the vacuum tap 126 and the distal end of the pipe 111 can be coupled to the regulator 108. The generation of pressure by the regulator 108 of the fuel along the fuel flow path generates a vacuum that helps to create the vacuum at the vacuum tap 126. The pipe 111 can represent one or multiple pipes and can be rigid or flexible (e.g., a rubber hose).

The system 100 can also include an engine 102. In one example, the engine 102 is an internal combustion engine that burns fuel. The engine 102 is configured to receive a mixture of fuel and air from the air-fuel mixing apparatus 101 and is configured to burn that fuel. In certain example embodiments, the fuel is propane. In other example embodiments, the fuel can be natural gas, gasoline, a hydrocarbon, or another source of energy for a combustion engine.

The air-fuel mixing apparatus 101 and the system 100 it is provided in may be configured to diffuse a fuel into an air flow, and provide an air-fuel mixture to an engine 102. The venturi valve 120 facilitates a fuel-air mixture to provide to the engine 102. The ratio of the fuel-air mixture may vary based on the controlled flow and diffusion of the fuel into the air flow, and the fuel-air mixture can be controlled to complement an engine's operating characteristics and/or needs. The fuel received via the fuel inlet port 122 may mix with and be diffused within the air flow in the venturi valve 120 and further mixed in the third channel or passageway in the transfer conduit 130. In this manner, no modifications to an existing and/or conventional carburation system may be needed, and the fuel-air mixture may be transported in line with the carburation system. In certain example embodiments, undesired emissions can be reduced by use of the air-fuel mixing apparatus 101 within the system 100, because the fuel may be sufficiently diffused and mixed within the air flow, for instance, in a venturi valve 120 and within the third channel or passageway as the passageway bends around and causes a variety of velocities and increase turbulence within the air-fuel mixture to change the flow of the air-fuel mixture from the first direction to the second direction. The relatively efficient diffusion of the fuel within the air flow to create the air-fuel mixture, and the provision of the air-fuel mixture inline within the carburetion system to an engine 102 results in a more precise application of only the desired amount of fuel into the air flow of the carburetion system and a more even diffusion of this precise fuel amount into the in-line air flow of the carburetion system, which permits a combustion engine to more thoroughly burn the fuel-air mixture and thus achieve higher engine efficiencies and lower emissions.

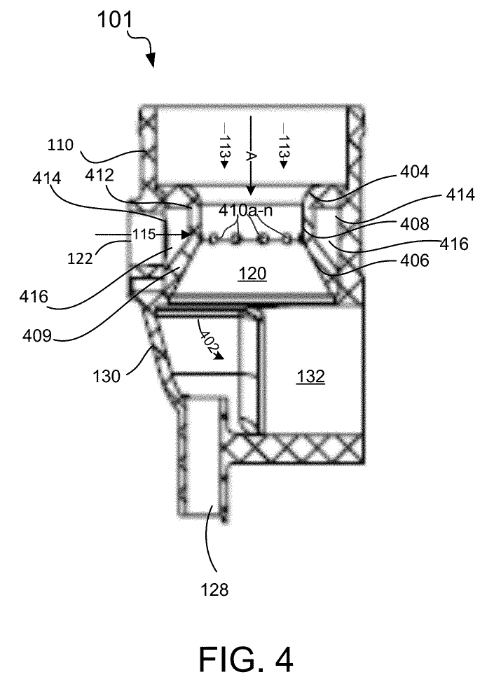

FIG. 4 illustrates a cross-sectional view of the air-fuel mixing apparatus 101. Referring now to FIGS. 1, 2, and 4, the venturi valve 120 is positioned within the passageway or channel 118 near the bottom end of the entry conduit 110. The venturi valve 120 or the venturi valve and the entry conduit 110 can include a fuel diffusion chamber 416 disposed about the outer surface 412 of the inner wall 409 of at least a portion of the throat section 408 and the diverging section 406. In one example, the volume defining the fuel diffusion chamber 416, can be defined by the space or void between at least the outer surface 412 of the inner wall 409 and an inner surface of an outer wall 414 of the venturi valve 120. In another example embodiment, the outer wall 414 of the venturi valve 120 can be eliminated and the volume defining the fuel diffusion chamber 416, can be defined by the space or void between at least the outer surface 412 of the inner wall 409 and inner wall 114 of the entry conduit 110. The fuel diffusion chamber 416 can have a generally annular shape about the perimeter of the outer surface 412 of the inner wall 409 of the venturi valve 120. In one example embodiment, the fuel diffusion chamber 416 can be a volume for receiving the fuel via the fuel flow path 115 into the air-fuel mixing apparatus 101 at an increased pressure/velocity. The fuel can impact the outer surface 412 of the inner wall 409 of the venturi valve 120. The impact can cause the fuel to move and diffuse about the perimeter of the inner wall 408 before being taken into the mixing chamber of the venturi valve 120 along the throat section 408. This diffusion of the fuel before allowing it to enter the venturi valve 120 to be mixed with air provides for a better and more consistent mixing of the fuel with the air.

The venturi valve 120 can include a converging section 404, a diverging section 406 and a throat section 408 positioned between the converging section 404 and the diverging section 406. The converging section 404 is positioned closer to the rim 116 than the throat section 408 and diverging section 406. The converging section 404 has an inner wall 409 that defines the diameter of the opening through the converging section 404. In one example, the cross-section of the inner wall 409 of the converging section 404 along a plane orthogonal to the longitudinal axis Y provides an inner wall 409 that has a circular or substantially circular cross-section. In certain example embodiments, the inner wall 409 of the converging section 404 is angled inwardly to reduce the diameter of the opening defined by the inner wall 409 as you move in the direction A along the longitudinal axis Y.

The diverging section 406 is positioned farther from the rim 116 than the throat section 408 and converging section 404. The diverging section 406 has an inner wall 409 that defines the diameter of the opening through the diverging section 406. In one example, the cross-section of the inner wall 409 of the diverging section 406 along a plane orthogonal to the longitudinal axis Y provides an inner wall 409 that has a circular or substantially circular cross-section. In certain example embodiments, the inner wall 409 of the diverging section 406 is angled outwardly to increase the diameter of the opening defined by the inner wall 409 as you move in the direction A along the longitudinal axis Y. The throat section 408 includes an inner wall 409 that has constant or substantially constant diameter. Alternatively, the inner wall 409 of the throat section 408 can be variable. The throat section 408 has a top end that converges with the converging section 404 and a distal bottom end that converges with the diverging section 408.

The venturi valve 120 can also include one or more fuel orifices 410a-410n disposed along the venturi valve 120. The number of fuel orifice not limited herein and can be any number of orifices including within the range of 1-100 fuel orifices 410a-410n. In one example embodiment, the fuel orifices 410a-410n are disposed along the inner wall 409 of the throat section 408 of the venturi valve 120. For example, the fuel orifices 410a-410n can be provided at or substantially near the convergence of the throat section 408 and the diverging section 406. In certain example embodiments, the fuel orifices 410a-410n can be positioned about a perimeter of the venturi valve 120 (e.g., about the perimeter of the inner wall 409 of the throat section 408). The fuel orifices 410a-410n can be disposed about the perimeter of the inner wall 409 alone or in groups and can be spaced equidistantly or not. Each fuel orifice 410a-410n can extend from the outer surface 412 of the inner wall 409 to the inner surface of the inner wall 409 of any one or more of the throat section 408, converging section 404, and/or diverging section 408. Each fuel orifice 410a-410n can provide a opening and passageway between the fuel diffusion chamber 416 and the mixing chamber along the throat section 408 of the venturi valve 120.

Air flowing along the air flow path 113 through the entry conduit 110 can flow in-line through the venturi valve 120. In operation, as the air flow enters the venturi valve 120 at the top of the converging section 404 (i.e., the portion of the converging section with the greatest cross-sectional diameter) it begins converging due to the converging inner wall 409 reducing the cross-sectional diameter, until it reaches the throat section 408. At the same or substantially the same time, fuel is received into the opening 124 of the fuel inlet port 122 via the fuel flow path 115 and into the air-fuel mixing apparatus 101 at an increased pressure/velocity provided, by example, by the regulator 108. The fuel can impact the outer surface 412 of the inner wall 409 of the venturi valve 120. The impact can cause the fuel to move and diffuse about the perimeter of the inner wall 408 in the fuel diffusion chamber 416 before being taken into the mixing chamber of the venturi valve 120 along the throat section 408. This diffusion of the fuel in the fuel diffusion chamber before allowing it to enter the venturi valve 120 allows the fuel to be more dispersed prior to mixing.

As the air flow enters the throat section 408, its velocity increases due to the smaller cross-sectional diameter of the inner wall 409 of the throat section 408 than that of the top end of the converging section 404. As the velocity of the air flow in the throat section 408 is increased there is a consequential drop in the pressure of the air flow. This drop in the pressure of the air flow creates at least a pressure differential between the throat section 408 of the venturi valve 120 and the fuel diffusion chamber 416. This pressure differential causes the fuel within the fuel diffusion chamber 416 to be drawn from the chamber 416 into the throat section 408 through the fuel orifices 410a-410n.

The air-fuel mixture 402 then moves into the third channel or passageway of the transfer conduit 130. This third channel or passageway may be integrally formed with the passageway or channel 118 and can just be a continuation thereof. As the air-fuel mixture 402 passes into the third channel or passageway of the transfer conduit 130, the flow of the air-fuel mixture 402 is changed from the first direction to the second direction as described above. This change of direction along the arcuate or substantially arcuate third channel or passageway creates a variation in the velocities of the air-fuel mixture and corresponding turbulence, causing the air-fuel mixture to further mix and further improving the consistency of the air-fuel mixture 402. The air-fuel mixture 402 can then pass through fifth channel or passageway 304 through the mounting plate 132 and into the engine 102.

Because the entry conduit 110 and the channel 304 in the mounting plate 132 are positioned at an angle to each other (e.g., 90 degrees), the air-fuel mixture may be more efficiently mixed and transported through the mounting plate 132 and to the engine.

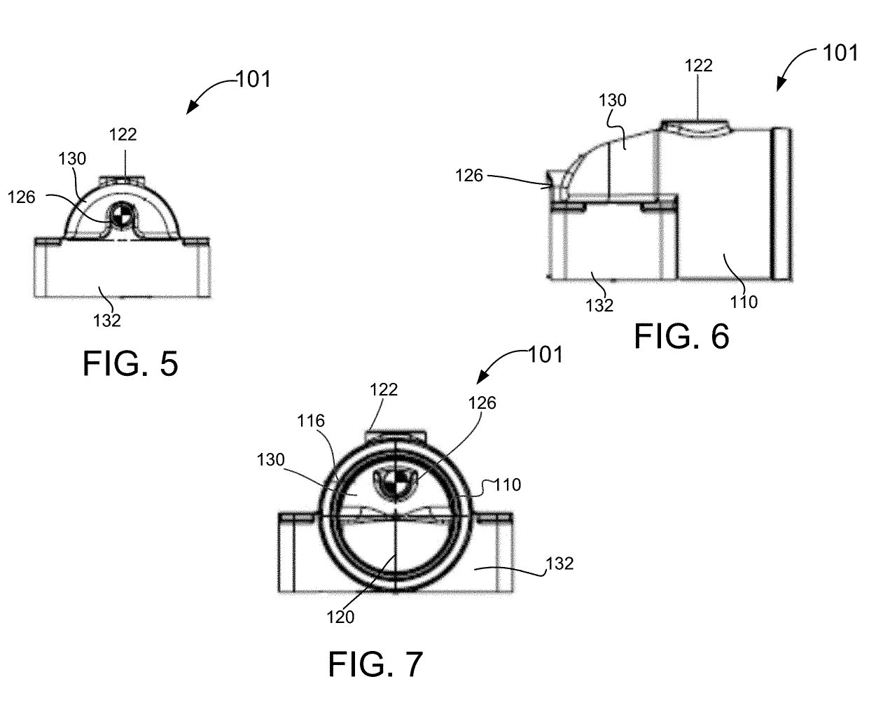

FIG. 5 is an elevation view of one end of the air-fuel mixing apparatus according to at least one example embodiment of the disclosure. FIG. 6 is another side elevation view of the air-fuel mixing apparatus according to at least one example embodiment of the disclosure. FIG. 7 illustrates an end view of the air-fuel mixing apparatus 101 from a perspective of the top end 116 of the entry conduit 110. Referring now to FIGS. 1-7, in one example embodiment, the height of the transfer conduit 130 may be between substantially 25.0 mm and substantially 30.0 mm. However, in other example embodiments, other dimensions for the transfer conduit 130 may be substituted for those provided herein. Furthermore, in certain example embodiments, the length from the top of the fuel inlet port 122 to the opposite side of the entry conduit 110 can be between substantially 65.0 mm and substantially 75.0 mm. However, in other example embodiments, other dimensions may be substituted for those provided herein.

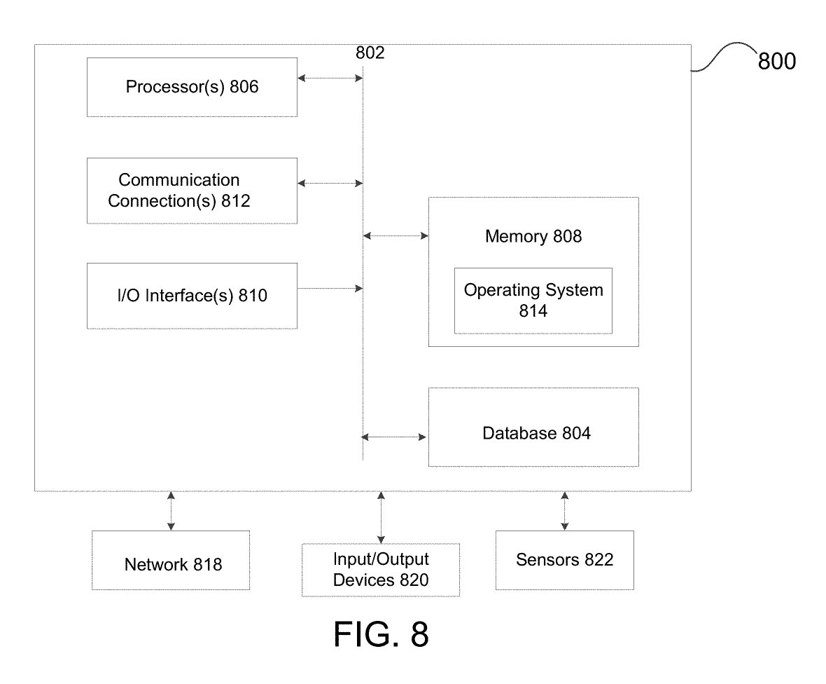

FIG. 8 illustrates a block diagram of an example data and/or control processing and output architecture or system 800 that may be utilized in accordance with various embodiments of the disclosure to facilitate operation of a combustion engine of the system 100. The architecture of the system 800 may include one or more computers and client devices in communication with one or more sensors 822. In certain example embodiments, communications between the computers, client devices, and/or sensors 822 may be facilitated via one or more suitable networks 818, such as the Internet, etc. In other embodiments, communications between the computers, client devices, and/or sensors 822 may be facilitated by wired and/or wireless communications.

As shown in FIG. 8, one or more computers, sensors 822, and/or client devices 802 may obtain and store information associated with operating characteristics of the system 100 and the air-fuel mixing apparatus 101 and/or associated components of an engine system. For example, operating characteristics may be stored in one or more databases 804. Each database 804 may contain data files for the operating characteristics. As desired, captured operating characteristics may be obtained from a wide variety of suitable sources, such as the sensors 822.

Any number of computers and/or client devices 802 may be provided. A computer and/or client device 802 may include any number of processor-driven devices, including, but not limited to, a server computer, a personal computer, one or more networked computing devices, an application-specific circuit, a minicomputer, a microcontroller, and/or any other processor-based device and/or combination of devices. A service provider computer may utilize one or more processors to execute computer-readable instructions that facilitate the general operation of the computer.

In addition to having one or more processors 806, the computer and/or client device 802 may further include one or more memory devices (generally referred to as memory) 808, one or more input/output (“I/O”) interface(s) 810, and/or one or more communication connections 812. The communication connections 812 may interface with a database, which may contain one or more data files, which may include operating characteristics. For example, the data files may include information associated with performance parameters, operating conditions, and the like for the air-fuel mixing apparatus 101 the engine 102, and/or any other components of the system 100.

The memory 808 may be any computer-readable medium, coupled to the one or more processors 806, such as random access memory (“RAM”), read-only memory (“ROM”), and/or removable storage devices. The memory may store one or more program modules utilized by the computer, such as an operating system (OS) 814. The one or more program modules may include an engine performance module capable of determining engine performance, fuel uses and needs, and the like.

Certain embodiments may be provided as a computer program product including a non-transitory machine-readable storage medium having stored thereon instructions (in compressed or uncompressed form) that may be used to program a computer (or other electronic device) to perform processes or methods described herein. For example, certain embodiments may be provided as a computer program product or group of products that may be executed by the computers or other suitable computing systems. The machine-readable storage medium may include, but is not limited to, hard drives, floppy diskettes, optical disks, CD-ROMs, DVDs, read-only memories (“ROMs”), random access memories (“RAMs”), EPROMs, EEPROMs, flash memory, magnetic or optical cards, solid-state memory devices, or other types of media/machine-readable medium suitable for storing electronic instructions. Further, embodiments may also be provided as a computer program product including a transitory machine-readable signal (in compressed or uncompressed form). Examples of machine-readable signals, whether modulated using a carrier or not include, but are not limited to, signals that a computer system or machine hosting or running a computer program can be configured to access, including signals downloaded through the Internet or other networks. For example, distribution of software may be an Internet download.

With reference to the contents of the memory 808, the data files may include any suitable data that facilitates the operation of the computer and/or interaction of the computer with one or more other components of the system 100, including but not limited to the air-fuel mixing apparatus 101, the engine 102, and the regulator 108, to adjust the rate of providing fuel into the air-fuel mixing apparatus 101 from the fuel tank 106.

The OS 814 may be any suitable module that facilitates the general operation of the computer, as well as the execution of other program modules. The one or more program modules, such as an air-fuel mixing apparatus operations module, a regulator operations module, and/or an engine performance module, may include one or more suitable software modules and/or applications. Additionally, the air-fuel mixing apparatus operations module, the regulator operations module, and/or the engine performance module may be configured to receive a wide variety of input from sensors 822 and/or a client device and to process the received input.

The client devices 802 may include any computing device such as a tablet, smart phone, wearable computer, or personal computer. The client devices 802 may include one or more processors 806. The one or more processors 806 may be implemented as appropriate in hardware, software, firmware, or combinations thereof. Software or firmware implementations of the one or more processors 806 may include computer-readable or machine-readable instructions written in any suitable programming language to perform the various functions described. The client devices 802, in addition to having one or more processors, may further include one or more memory devices (generally referred to as memory) 808, one or more input/output (“I/O”) interface(s) 810, and/or one or more communication connections 812. The communications connections 812 may interface with the network 818 to transmit information.

Similar to memory above, the memory 808 may be any computer-readable medium, coupled to the one or more processors of the client devices, such as random access memory (“RAM”), read-only memory (“ROM”), and/or removable storage devices. The memory 808 may store one or more program modules utilized by the client devices 802, such as an operating system (OS) 814.

The one or more I/O interfaces 810 may facilitate communication between the computers and one or more input/output devices 820. For example, one or more input/output devices 820 such as user interface devices can include, but are not limited to, a display, a keypad, a keyboard, a touch screen display, a microphone, a speaker, a mouse, or any other similar device that can facilitate user interaction. The one or more networks 818 and/or communication connections 812 may facilitate connection of the computers to any number of suitable networks, for example, the one or more network(s) 818. In this regard, the computers may receive and/or communicate information to other components of the system.

Any number of client devices 802 may be included in the system. A client device 802 may be configured to access one or more sensors 822 hosted by or in communication with the computers in order to review and/or manipulate captured sensor information. In certain embodiments, a client device 802 may include similar components as those discussed above for the computers. For example, a client device 802 may include any number of processors, memories, I/O interfaces, and/or network/communication interfaces.

A wide variety of suitable networks 818 (which may be the same or separate networks) and/or communication channels may be utilized to facilitate communications between the one or more sensors 822, client devices, the computers and/or other components of the system. These networks may include, but are not limited to, one or more telecommunication networks, cellular networks, wide area networks (e.g., the Internet), and/or local area networks. Various methodologies as described herein may be practiced in the context of distributed computing environments. It will also be appreciated that the various networks may include a plurality of networks, each with devices such as gateways and routers for providing connectivity between or among networks. Additionally, instead of, or in addition to, a network, dedicated communication links may be used to connect various devices in accordance with an example embodiment.

The processing and output architecture or system 800 described is provided by way of example only. Numerous other operating environments, system architectures, and device configurations are possible. Other architecture and system embodiments can include fewer or greater numbers of components and may incorporate some or all of the functionality described with respect to the architecture or system components shown. Accordingly, embodiments of the disclosure should not be construed as being limited to any particular operating environment, system architecture, or device configuration.

The disclosure is described above with reference to block and flow diagrams of systems, methods, apparatuses, and/or computer program products according to example embodiments of the disclosure. It will be understood that one or more blocks of the block diagrams and flow diagrams, and combinations of blocks in the block diagrams and the flow diagrams, respectively, can be implemented by computer-readable program instructions. Likewise, some blocks of the block diagrams and flow diagrams may not necessarily need to be performed in the order presented, or may not necessarily need to be performed at all, according to some embodiments of the disclosure.

Various block and/or flow diagrams of systems, methods, apparatus, and/or computer program products according to example embodiments of the disclosure are described above. It will be understood that one or more blocks of the block diagrams and flow diagrams, and combinations of blocks in the block diagrams and flow diagrams, respectively, can be implemented by computer-readable program instructions. Likewise, some blocks of the block diagrams and flow diagrams may not necessarily need to be performed in the order presented, or may not necessarily need to be performed at all, according to some embodiments of the disclosure.

These computer-executable program instructions may be loaded onto a special purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks. As an example, embodiments of the disclosure may provide for a computer program product, comprising a computer-usable medium having a computer-readable program code or program instructions embodied therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, can be implemented by special purpose, hardware-based computer systems that perform the specified functions, elements or steps, or combinations of special purpose hardware and computer instructions.

Many modifications and other embodiments of the disclosure set forth herein will be apparent having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. An apparatus configured to provide an air-fuel mixture to an engine, the apparatus comprising:
a mixing conduit comprising:
an opening for receiving air;
a channel disposed within the mixing conduit and comprising a straight channel portion and an arcuate channel portion;
a venturi valve fluidicly coupled to the mixing conduit;
a fuel inlet port fluidicly coupled to mixing conduit; and
a mounting plate.

2. The apparatus of claim 1, wherein the straight channel portion comprises a first end disposed at the opening and a distal second end.

3. The apparatus of claim 2, wherein the curved channel portion has a first end fluidicly coupled to and extending from the second end of the straight channel portion and a distal second end of the curved channel portion.

4. The apparatus of claim 3, wherein the mounting plate comprises:
a first mounting surface;
an opposing second mounting surface; and
an air-fuel mixture delivery channel extending through the mounting plate; wherein the air-fuel mixture delivery channel is fluidicly coupled to the second end of the curved channel portion.

5. The apparatus of claim 4, wherein the straight channel portion extends along a first longitudinal axis and the second end of the curved channel portion extends along a second longitudinal axis offset from the first longitudinal axis at a non-zero angle.

6. The apparatus of claim 5, wherein the non-zero angle is within the range of substantially 30 degrees to substantially 150 degrees.

7. The apparatus of claim 5, wherein the non-zero angle is substantially 90 degrees.

8. The apparatus of claim 4, wherein the mounting plate further comprises:
a plurality of mounting apertures extending from the first mounting surface to the second mounting surface; and
a plurality of coupling devices, each of the plurality coupling devices being configured to extend through a corresponding mounting aperture to couple the mounting plate to an engine.

9. The apparatus of claim 1, wherein the mixing conduit further comprises:
an outer wall; and
an inner wall defining the channel.

10. The apparatus of claim 9, wherein the fuel inlet port defines a second channel extending through the outer wall and the inner wall of the mixing conduit and fluidicly coupled to the channel.

11. The apparatus of claim 1, wherein the venturi valve is disposed within the channel of the mixing conduit.

12. The apparatus of claim 11, wherein the venturi valve comprises:
an inner wall defining:
a converging section;
a diverging section; and
a throat section defining a mixing chamber disposed between the converging section and the diverging section;
a plurality of fuel orifices disposed through the inner wall; and
a fuel diffusion chamber disposed about at least a portion of an exterior of the inner wall, wherein the fuel diffusion chamber is fluidicly coupled to the fuel inlet port.

13. The apparatus of claim 11, wherein the fuel diffusion chamber is fluidicly coupled to the mixing chamber via the plurality of fuel orifices.

14. The apparatus of claim 1, further comprising a vacuum tap coupled to the mixing conduit and comprising:
a first vacuum tap end;
a distal second vacuum tap end;
a third channel extending through the vacuum tap from the first vacuum tap end to the second vacuum tap end and fluidicly coupled to the channel of the mixing conduit.

15. An apparatus configured to provide an air-fuel mixture to a combustion engine, the apparatus comprising:
an entry conduit comprising:
an inner wall defining a straight channel;
an opening along a first end of the entry conduit and fluidicly coupled to the straight channel;
a fuel inlet port disposed through the inner wall of the entry conduit and configured to supply fuel into the straight channel;
a venturi valve disposed within the straight channel;
a transfer conduit coupled to the entry conduit and comprising an arcuate channel having a first end fluidicly coupled to the straight channel and a distal second end; and
a mounting surface coupled to the transfer conduit.

16. The apparatus of claim 15, wherein the entry conduit and the transfer conduit are integrally formed.

17. The apparatus of claim 15, wherein the entry conduit, the transfer conduit, and the mounting surface are integrally formed.

18. The apparatus of claim 15,
wherein the venturi valve comprises:
an air-fuel mixing chamber;
an inner wall comprising a plurality of fuel orifices disposed through the inner wall; and
a fuel diffusion chamber disposed about at least a portion of an exterior of the inner wall, wherein the fuel diffusion chamber is fluidicly coupled to the fuel inlet port and the air-fuel mixing chamber.

19. The apparatus of claim 15, wherein the straight channel extends along a first longitudinal axis and the second end of the arcuate channel extends along a second longitudinal axis offset from the first longitudinal axis at a non-zero angle between substantially 60 degrees and substantially 120 degrees.

20. An apparatus configured to provide an air-fuel mixture to a combustion engine, the apparatus comprising:
an entry conduit comprising:
an inner wall defining a straight channel;
an opening along a first end of the entry conduit and fluidicly coupled to the straight channel, the opening configured to receive air into the straight channel along a first longitudinal axis;
a fuel inlet port disposed through the inner wall of the entry conduit and configured to supply fuel into the straight channel along a second longitudinal axis substantially perpendicular to the first longitudinal axis;
a venturi valve disposed within the straight channel and comprising:
an air-fuel mixing chamber;
an inner wall comprising a plurality of fuel orifices disposed through the inner wall; and
a fuel diffusion chamber disposed about at least a portion of an exterior of the inner wall, wherein the fuel diffusion chamber is fluidicly coupled to the fuel inlet port and the air-fuel mixing chamber;
a transfer conduit coupled to the entry conduit and comprising an arcuate channel having a first end fluidicly coupled to the straight channel and a distal second end, wherein the second end of the arcuate channel extends along the second longitudinal axis; and
a mounting surface coupled to the transfer conduit.
